(19) United States
(12) Patent Application Publication
(10) Pub. No.: US 2013/0056588 A1
(43) Pub. Date: Mar. 7, 2013

(54) ARRANGEMENT RELATED TO GUIDING OF HOSES AND/OR CABLES

(71) Applicants: Joakim Harr, Vindeln (SE); Lars Mikaelsson, Vindeln (SE)

(72) Inventors: Joakim Harr, Vindeln (SE); Lars Mikaelsson, Vindeln (SE)

(21) Appl. No.: 13/261,470

(22) PCT Filed: Apr. 12, 2011
(86) PCT No.: PCT/SE2011/000066

§ 371 Date: Oct. 10, 2012

(30) Foreign Application Priority Data
Apr. 13, 2010 (SE) SE1000373-9

(51) Int. Cl. F16L 3/01; B66C 13/14

(52) U.S. Cl. 248/49

(57) ABSTRACT

The invention relates to a device for guiding hoses and/or cables miming from a crane jib via its nose portion, wherein a first/upper swing joint (50) is arranged between the crane nose (11) and a link device (40) and a second/lower swing joint (80) is arranged between the link device (40) and an accessory/tool in the form of e.g. a rotator (75). The upper swing joint (50) includes a means (20) for the guiding of the hoses (91-94) and/or cables.

### TECHNICAL FIELD

This invention relates to a device for guiding hoses and/or cables running from a crane jib at its nose portion according to the pre-characterising part of claim 1.

### BACKGROUND OF THE INVENTION

Hoses are used for the communication of pressure medium for driving, e.g. rotators and working implements. The hoses normally run from a pressure medium source along, and sometimes inside, a crane jib which, in its nose portion via a link, e.g. supports a rotator and a working tool arranged below the rotator. Electricity is sometimes used and corresponding considerations thus apply to electric cables. It has proven difficult to provide efficient hosing and/or cabling as a result of the pattern of movements executed by the crane jib with the attached accessory/implement as the hoses/cables are often exposed to surrounding objects that risk causing damage to the hoses/cables.

### AIM OF THE INVENTION

One aim of this invention is to provide an extremely advantageous device for guiding hoses and/or cables running from a crane jib via its nose portion. This aim is achieved in that the device has the features specified in the claims.

### ADVANTAGES OF THE INVENTION

The hosing and/or cabling according to the invention is arranged in such a manner that the risk of damage to the hoses and/or cables is virtually eliminated. The invention offers both technical and economic advantages.

### BRIEF DESCRIPTION OF THE DRAWINGS

Embodiments of the invention will now be described with reference to the accompanying drawings.

FIG. 1 is an exploded view of the device according to the invention.

FIGS. 2 and 3 are perspective views of a first hosing arrangement according to the invention.

FIGS. 4 and 5 are perspective views of a second hosing arrangement according to the invention.

### DETAILED DESCRIPTION OF ILLUSTRATED EMBODIMENTS

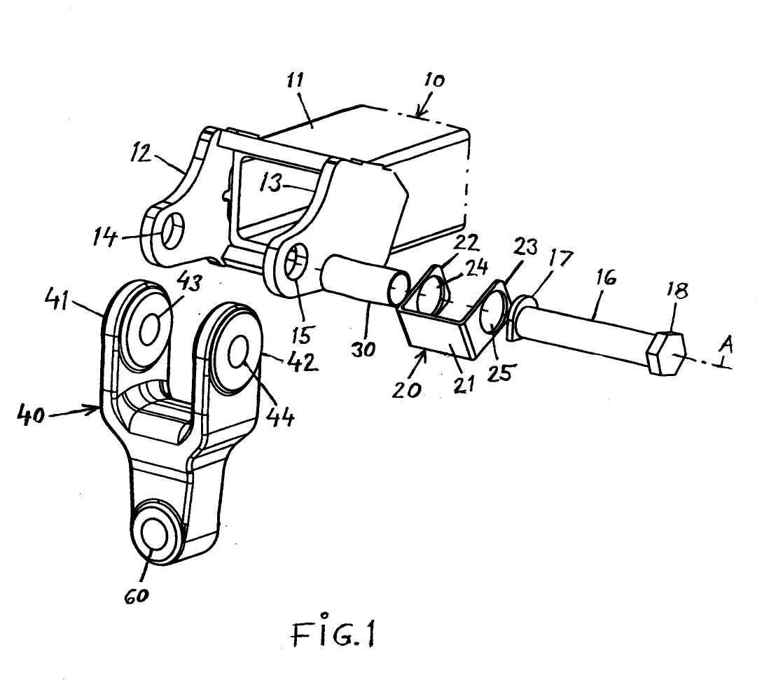

FIG. 1 shows a crane jib 10 with a nose portion 11 supporting two side plates 12, 13 each comprising a hole 14 and 15 respectively for the attachment of a pin 16 with a head 17 and a nut 18.

The invention furthermore includes a means 20 for the guiding of hoses and/or cables. The guiding means 20 comprises a flat central part 21 and two legs 22, 23. The legs 22, 23 each comprise a hole 24 and 25 respectively for attachment to a sliding sleeve 30 or to the pin 16. The function of the sliding sleeve 30 is to serve as a sliding bearing when necessary and it may consist of a plastic tube. The flat central part 21 may of course also have a non-flat shape if appropriate.

A link device 40 is provided at its upper end with two lugs 41, 42 arranged at a distance from one another and each comprising a hole 43 and 44 respectively. The pin 16 extends through the holes 14, 15 in the side plates 12, 13 and through the holes 43, 44 in the lugs 41, 42 so that an upper swing joint 50 is formed between the crane nose 11 and the link device 40.

The guiding means 20 and, where applicable, the sliding sleeve 30 are arranged on the pin 16 in a region between the lugs 41, 42 of the link device 40. The upper swing joint 50 swings about an axis A.

The link device 40 is provided at its lower end with a hole 60 cooperating with holes 70, 71 in two fastening lugs 73, 74 arranged at a distance from one another on a rotator 75. A pin (not shown) runs through the holes 60, 70, 71 so that a lower swing joint 80 is formed. The lower swing joint 80 swings about an axis B. The swing axes A and B are at right angles to one another in this embodiment, meaning that the link device 40 acts like a universal joint so that the rotator 75 can swing relative to the crane jib 10 about the two different axes A and B. It should be noted that the lower end of the link device 40 may also include a brake device. The link device 40 may also include a weighing function.

The lower end 76 of the rotator comprises fastening points for an implement fastener and/or a working implement in the form of, e.g. a gripper or a processor unit, etc. Connection points for the transmission of pressure medium and/or the transmission of electricity to the relevant implement are arranged at the lower end 76 of the rotator.

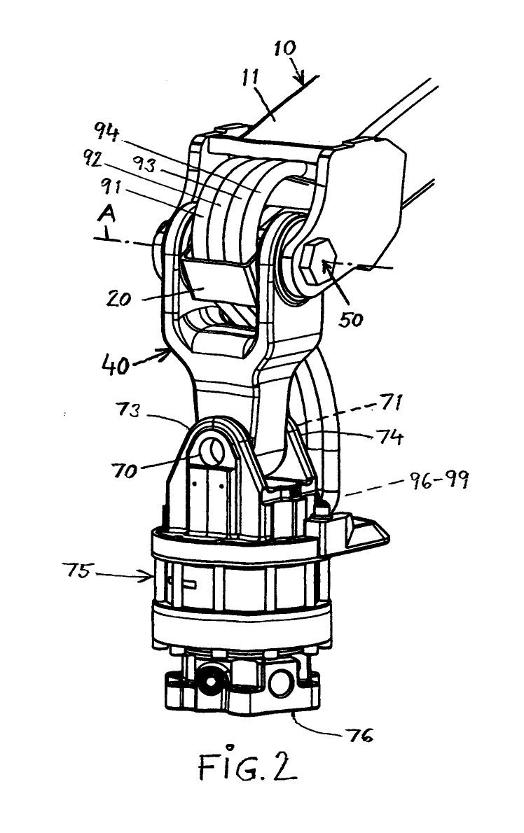

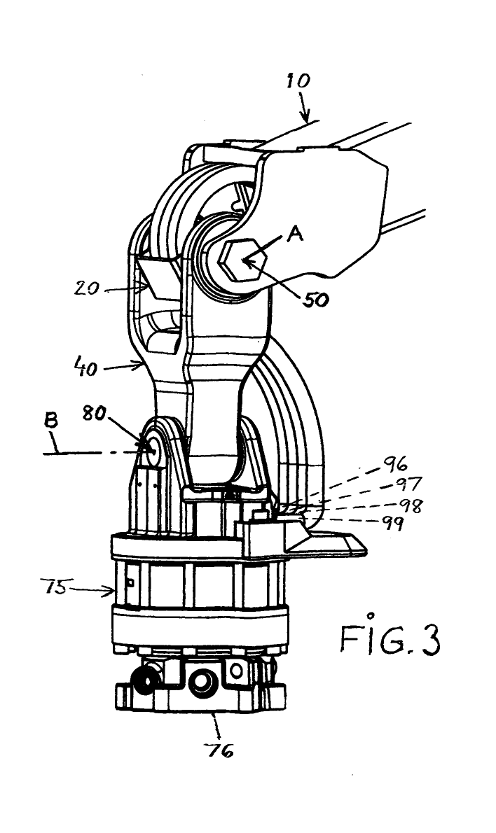

FIGS. 2 and 3 show embodiments of a hosing arrangement according to the invention, e.g. in the case of what is referred to as a forwarder application. In the embodiment shown, hoses 91-94 extend from the inner region of the crane jib 10 and run above the upper bearing 50, while the hoses 91-94 are simultaneously located inside the upward guiding means 20 so that the hoses are guided at the bearing 50, after which the hoses continue to the connection points 96-99 on the side of the rotator 75 directed towards the crane jib 10. The hosing arrangement shown means that the hoses 91-94 are collected together in an organised manner and are well protected from external influences in connection with the relevant operating cycles of the device in question. The same conditions and considerations apply in the case of electric cables.

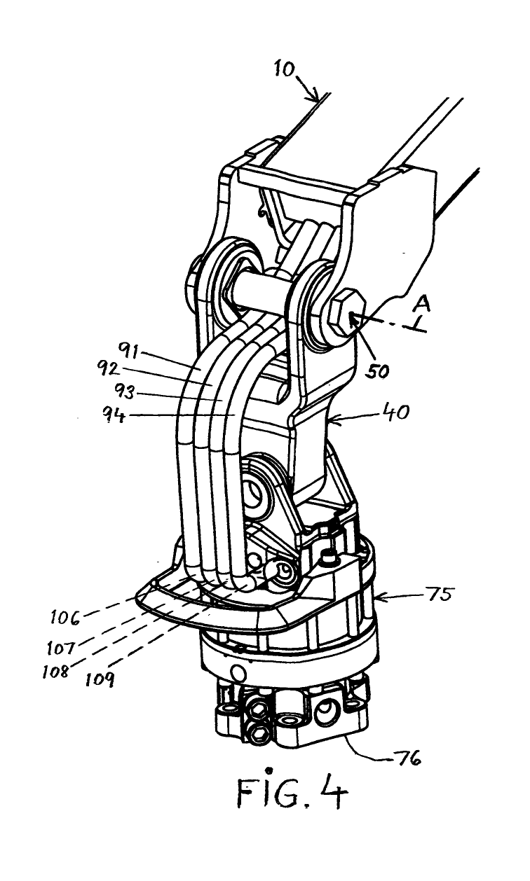

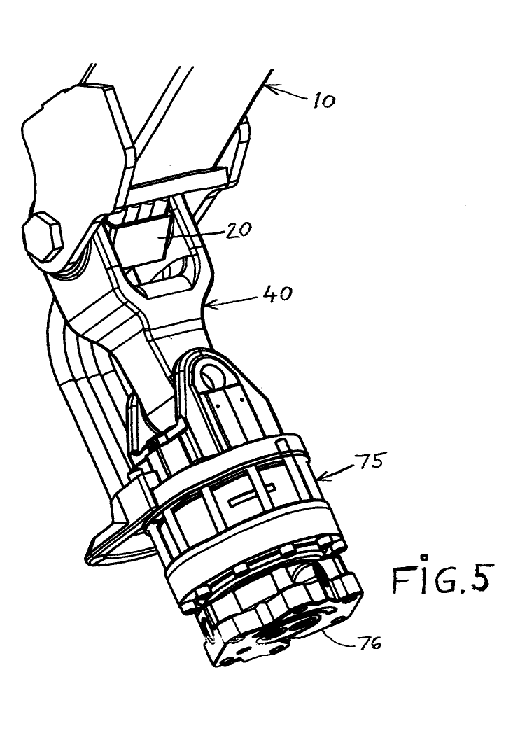

FIGS. 4 and 5 show embodiments of a hosing arrangement according to the invention, e.g. in the case of what is referred to as a lorry application. In the embodiment shown, the hoses 91-94 extend from the inner region of the crane jib 10 and run under the upper bearing 50, while the hoses simultaneously run inside the guiding means 20 and are guided at the bearing 50, after which the hoses continue to the connection points 106-109 on the side of the rotator 75 directed away from the crane jib 10. In this case, the rotator 75 points in the opposite direction to that shown in FIGS. 2 and 3. The hosing arrangement shown means that the hoses 91-94 are collected together in an organised manner and are well protected from external influences during the operating cycles performed. The same conditions and considerations apply in the case of electric cables.

In general, the rotary position of the guiding means 20 is automatically adapted to the pattern of movements of the hoses/cables as the guiding means is rotatably mounted relative to the pin 16.

As indicated hereinabove, the sliding sleeve 30 thus facilitates the rotary bearing function, although this can be omitted under certain conditions provided that a direct bearing between the upward guiding means 20 and the pin 16 provides the required function. The sliding sleeve 30 may also be designed to be shorter than the distance between the legs 22 and 23, the sliding sleeve 30 only being provided to facilitate the movements of the hoses/cables during operation of the crane.

It will be clear that the details of the design of the guiding means 20 may be varied, the essential point being that the hoses/cables are guided relative to the upper swing joint 50.

In the embodiments shown, the hoses/cables run internally in the crane jib 10, but it will be clear that the invention may also be applied to embodiments in which the hoses/cables run externally on the crane jib 10.

The invention is thus not limited to what is illustrated and described here and amendments and modifications are of course conceivable within the scope of the following claims.

1. Device for guiding hoses and/or cables running from a crane jib via its nose portion, wherein a first/upper swing joint (50) is arranged between the crane nose (11) and a link device (40) and a second/lower swing joint (80) is arranged between the link device (40) and an accessory/tool in the form of, e.g. a rotator (75), characterised in that the upper swing joint (50) includes a means (20) for guiding the hoses (91-94) and/or cables.

2. Device according to claim 1, characterised in that the upper swing joint (50) includes a pin (16) supporting the guiding means (20) and that the guiding means (20) can swing relative to the pin (16).

3. Device according to claim 1, characterised in that the hoses (91-94) and/or cables are connected to the accessory/tool (75).

4. Device according to claim 1, characterised in that the guiding means (20) comprises a central portion (21) and two legs (22, 23) and that the legs (22, 23) each comprise a hole (24, 25) for attachment to a sliding sleeve (30) or to a pin (16).

5. Device according to claim 4, characterised in that the central portion (21) of the guiding means (20) is flat.

6. Device according to claim 1, characterised in that the hoses (91-94) and/or cables run in such a manner that they extend through an inner space in the guiding means (20).

7. Device according to claim 1, characterised in that the hoses (91-94) and/or cables run inside the crane nose (11) and on top of the pin (16).

8. Device according to claim 1, characterised in that the hoses (91-94) and/or cables run inside the crane nose (11) and on the underside of the pin (16).

9. Device according to claim 1, characterised in that the hoses (91-94) and/or cables are connected to the accessory/tool (75) on a side directed towards the crane jib (10).

10. Device according to claim 1, characterised in that the hoses (91-94) and/or cables are connected to the accessory/tool (75) on a side directed away from the crane jib (10).

11. Device according to claim 2, characterised in that the hoses (91-94) and/or cables are connected to the accessory/tool (75).

12. Device according to claim 2, characterised in that the guiding means (20) comprises a central portion (21) and two legs (22, 23) and that the legs (22, 23) each comprise a hole (24, 25) for attachment to a sliding sleeve (30) or to a pin (16).

13. Device according to claim 2, characterised in that the hoses (91-94) and/or cables run in such a manner that they extend through an inner space in the guiding means (20).

14. Device according to claim 2, characterised in that the hoses (91-94) and/or cables run inside the crane nose (11) and on top of the pin (16).

15. Device according to claim 2, characterised in that the hoses (91-94) and/or cables run inside the crane nose (11) and on the underside of the pin (16).

16. Device according to claim 2, characterised in that the hoses (91-94) and/or cables are connected to the accessory/tool (75) on a side directed towards the crane jib (10).

17. Device according to claim 2, characterised in that the hoses (91-94) and/or cables are connected to the accessory/tool (75) on a side directed away from the crane jib (10).

18. Device according to claim 3, characterised in that the guiding means (20) comprises a central portion (21) and two legs (22, 23) and that the legs (22, 23) each comprise a hole (24, 25) for attachment to a sliding sleeve (30) or to a pin (16).

19. Device according to claim 3, characterised in that the hoses (91-94) and/or cables run in such a manner that they extend through an inner space in the guiding means (20).

20. Device according to claim 3, characterised in that the hoses (91-94) and/or cables run inside the crane nose (11) and on top of the pin (16).
